(19) United States
(12) Patent Application Publication
(10) Pub. No.: US 2026/0261947 A1
(43) Pub. Date: Sep. 3, 2026

(54) SYSTEM AND METHOD OF PROVIDING HANDOVER RESTRICTION DECISIONS

(71) Applicant: JIO PLATFORMS LIMITED, Ahmedabad, Gujarat (IN)

(72) Inventors: Arpan NANDA, Navi Mumbai, Maharashtra (IN); Barid Baran NAYAK, Bhubaneswar, Odisha (IN); Bibekananda JENA, Navi Mumbai, Maharashtra (IN); Aayush BHANTNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/881,845

(22) PCT Filed: Dec. 15, 2023
(86) PCT No.: PCT/IB2023/062779

§ 371 Date: Jan. 7, 2025

(30) Foreign Application Priority Data
Dec. 16, 2022 (IN) 202221073210

(51) Int. Cl. H04W 36/30; H04W 12/06; H04W 36/36

(52) U.S. Cl. CPC H04W 36/304; H04W 12/06; H04W 36/362

(57) ABSTRACT

The present disclosure relates to a system and a method for optimizing handover decisions. In particular, the method includes determining that a user equipment is currently connected to a first radio access technology type, for example, a third generation partnership project (3GPP) based network type. Further, the method includes determining a second radio access technology type for a handover. In response to the second radio access technology type, the method includes extracting information from a new radio (NR) cell global identifier. Based on the extracted information, the method includes determining a handover decision whether to allow or reject the handover from the first radio access technology type to the second radio access technology type.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure relates generally to handover mechanism in telecommunications network. In particular, the present disclosure relates to optimizing handover restriction decisions if doing so can result in poor throughput experience for users.

### BACKGROUND OF INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

3^{rd} Generation Partnership Project (3GPP) specification provides a mechanism for handover of user internet connectivity from a 3GPP based network type, i.e., cellular to non-3GPP based network type, i.e., wireless-fidelity (Wi-Fi) and vice-a-versa. Due to different standards involved in non-3GPP radio access, throughput available in different generation of Wi-Fi (Wi-Fi 4, 5, 6) evolves differently compared to 3GPP radio access.

Thus, handover from 3GPP access such as Fifth Generation (5G) can lead to poor throughput experience in Wi-Fi in case the user is trying to connect to Wi-Fi 4, 5 which has a substantial lower throughput compared to 5G access.

In particular, handover from 5G to Wi-Fi 4, 5 can lead to degradation of experience and throughput, since Wi-Fi throughput is substantially lower than the 5G throughput.

Therefore, there is a well-felt need for an improved and efficient mechanism for performing and/or providing handover decisions that addresses at least the above-mentioned issues and shortcomings.

### OBJECTS OF THE INVENTION

An object of the present disclosure is to provide an efficient approach towards handover restriction.

An object of the present disclosure is to avoid throughput degradation in case of handover.

An object of the present disclosure is to ensure that user experience is maintained, and not degraded, due to handover to a wireless-fidelity (Wi-Fi) network.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for providing handover restriction decisions. The system includes a processor and a memory operatively coupled with the processor, where said memory stores instructions which, when executed by the processor, cause the processor to receive a connection request from a user equipment (UE) for connecting to a non-third generation partnership project (non-3GPP) access network. The UE is connected to a 3GPP access network, where the connection request includes an identifier associated with the UE. The processor authenticates the UE based on the identifier. The processor, responsive to the authentication, transmits a query to a home subscriber server (HSS) and unified data management (UDM) server regarding the UE. The processor receives information associated with the UE via the HSS and UDM server based on the query. The processor determines a type of the 3GPP access network of the UE and extracts radio frequency information based on the information. The processor determines a handover restriction decision of the UE based on comparing the radio frequency information, of a cell to which the UE is attached in the 3GPP access network, with the identifier.

In an embodiment, the type of the 3GPP access network may include one of 4G network or 5G network, wherein the processor may allow a handover of the UE from the 4G network to the non-3GPP access network.

In an embodiment, in case of the 3GPP access network being the 5G network, the processor may determine a generation of Wireless Fidelity (Wi-Fi) of the non-3GPP access network requested by the UE based at least on the identifier.

In an embodiment, in case of the generation of the Wi-Fi being Wi-Fi 6, the processor may allow the handover of the UE from the 5G network to the Wi-Fi 6, and in case of the generation of the Wi-Fi being Wi-Fi 4, 5, the processor may determine if the UE is connected to a low throughput band of the 5G network or a high throughput band of the 5G network based on the radio frequency information.

In an embodiment, in case of the UE being connected to the low throughput band of the 5G network, the processor may allow the handover of the UE from the 5G network to the non-3GPP access network, and in case of the UE being connected to the high throughput band of the 5G network, the processor may reject the handover of the UE.

In an embodiment, the identifier may include a called station ID including at least one of a basic service set identifier (BSSID), a SSID, and an access point (AP) group name, and the SSID may include a network name of the non-3GPP access network requested by the UE.

In an embodiment, the information may include at least one of connection status of the UE and location information of the UE.

In an aspect, a method for providing handover restriction decisions includes receiving, by a processor associated with a system, a connection request from a UE for connecting to a non-3GPP access network. The UE is connected to a 3GPP access network, where the connection request includes an identifier associated with the UE. The method includes authenticating, by the processor, the UE based on the identifier. The method includes responsive to the authentication, transmitting, by the processor, a query to a HSS and UDM server regarding the UE. The method includes receiving, by the processor, information associated with the UE via the HSS and UDM server based on the query. The method includes determining, by the processor, a type of the 3GPP access network of the UE and extracting radio frequency information based on the information. The method includes determining, by the processor, a handover restriction decision of the UE based on comparing the radio frequency information, of a cell to which the UE is attached in the 3GPP access network, with the identifier.

In an embodiment, the type of the 3GPP access network may include one of 4G network or 5G network, wherein the method may include allowing, by the processor, a handover of the UE from the 4G network to the non-3GPP access network.

In an embodiment, in case the 3GPP access network is the 5G network, the method may include determining, by the processor, a generation of Wireless Fidelity (Wi-Fi) of the non-3GPP access network, requested by the UE, based at least on the identifier.

In an embodiment, in case the generation of the Wi-Fi is Wi-Fi 6, the method may include allowing, by the processor, the handover of the UE from the 5G network to the Wi-Fi 6, and in case the generation of the Wi-Fi is Wi-Fi 4, 5, the method may include determining, by the processor, if the UE is connected to a low throughput band of the 5G network or a high throughput band of the 5G network based on the radio frequency information.

In an embodiment, in case the UE is connected to the low throughput band of the 5G network, the method may include allowing, by the processor, the handover of the UE from the 5G network to the non-3GPP access network, and in case the UE is connected to the high throughput band of the 5G network, the method may include rejecting, by the processor, the handover of the UE.

In an embodiment, the identifier may include a called station ID including at least one of a BSSID, a SSID, and an AP group name, and the SSID may include a network name of the non-3GPP access network requested by the UE.

In an embodiment, the information may include at least one of connection status of the UE and location information of the UE.

In an aspect, a UE for sending requests may include one or more processors communicatively coupled to a processor associated with a system. The one or more processors are coupled with a memory, and where said memory stores instructions which, when executed by the one or more processors, cause the one or more processors to transmit a connection request to the processor for connecting to a non-3GPP access network, wherein the UE is connected to a 3GPP access network, and wherein the connection request includes an identifier associated with the UE, wherein the processor is configured to authenticate the UE based on the identifier, responsive to the authentication, transmit a query to a HSS and UDM server regarding the UE, receive information associated with the UE via the HSS and UDM server based on the query, determine a type of the 3GPP access network of the UE and extract radio frequency information based on the information, and determine a handover restriction decision of the UE based on comparing the radio frequency information, of a cell to which the UE is attached in the 3GPP access network, with the identifier.

In an aspect, a non-transitory computer readable medium includes a processor with executable instructions, causing the processor to receive a connection request from a UE for connecting to a non-3GPP access network. The UE is connected to a 3GPP access network, and where the connection request includes an identifier associated with the UE. The processor authenticates the UE based on the identifier. The processor responsive to the authentication, transmits a query to a HSS and UDM server regarding the UE. The processor receives information associated with the UE via the HSS and UDM server based on the query. The processor determines a type of the 3GPP access network of the UE and extracts radio frequency information based on the information. The processor determines a handover restriction decision of the UE based on comparing the radio frequency information, of a cell to which the UE is attached in the 3GPP access network, with the identifier.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary system architecture 100 for data offloading handover restriction of a user, in accordance with embodiments of the present disclosure.

FIG. 2 illustrates an example block diagram 200 of a proposed system 104, in accordance with an embodiment of the present disclosure.

FIG. 3 illustrates an exemplary signal flow diagram 300 of the proposed system 104, in accordance with embodiments of the present disclosure.

FIG. 4 illustrates a format of a new radio (NR) cell global identifier (NCGI) 400, in accordance with embodiments of the present disclosure.

FIG. 5 illustrates an exemplary flow diagram 500 of a method for providing handover restriction decisions, in accordance with embodiments of the present disclosure.

FIG. 6 illustrates an exemplary computer system 600 in which or with which embodiments of the present disclosure may be implemented.

The foregoing shall be more apparent from the following more detailed description of the disclosure.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the disclosure, various embodiments are described using terms used in some communication standards (for example, 3rd generation partnership project (3GPP), but these are merely examples for description. Various embodiments of the disclosure may also be easily modified and applied to other communication systems.

The present disclosure relates to systems and methods for data offloading handover restriction from a first radio access technology (RAT) type to a second RAT type, where the system primarily includes a user equipment, an access point, and a network entity. In an embodiment, the first RAT type belongs to a 3GPP based access service such as fourth generation/long-term evolution/fifth generation (4G/5G) service, whereas the second RAT type belongs to non-3GPP based access service such as Wi-Fi services. Further, the first RAT type service may be provided to the user equipment through a radio access network and the second RAT type service may be provided to the user equipment through a Wi-Fi network formed by the access point.

3GPP specification provides mechanism for handover of user internet connectivity from a first RAT type (for example, cellular) to a second RAT type (for example, Wi-Fi) and vice-a-versa. A person of ordinary skill in the art will understand that cellular network is standardized by 3GPP, whereas Institute of Electrical and Electronics Engineers (IEEE) and Wi-Fi Alliance standardize non-3GPP access network such as Wi-Fi. Due to different standards involved in non-3GPP radio access, throughput available in different generation of Wi-Fi (for example, Wi-Fi 4, 5, 6) evolves differently compared to 3GPP radio access (for example, 4G, 5G). Therefore, handover from 3GPP radio access such as 5G may lead to poor throughput experience in Wi-Fi in case the user is trying to connect to Wi-Fi 4, 5 which has a substantial lower throughput compared to 5G access. The present disclosure provides restricting the handover from a 3GPP based RAT type such as 5G to a non-3GPP based RAT type such as Wi-Fi if doing so can result in poor throughput experience for users.

It may be appreciated that the present solution is applicable to Wi-Fi data offload service as described in 3GPP TS 23.402 for universal integrated circuit card (UICC) based subscribers in a telecommunications network.

Certain terms and phrases have been used throughout the disclosure and will have the following meanings in the context of the ongoing disclosure.

The term “3GPP” is a 3rd Generation Partnership Project or 3GPP and is a collaborative project between a group of telecommunications associations with the initial goal of developing globally applicable specifications for Third Generation (3G) mobile systems. 3GPP specifications cover cellular telecommunications technologies, including radio access, core network, and service capabilities, which provide a complete system description for mobile telecommunications. The 3GPP specifications also provide hooks for non-radio access to the core network, and for networking with non-3GPP networks.

The term “network entity” may refer to an entity that serves a cellular network for providing voice services (i.e., calls) and data services to a user equipment. The network entity may include, but not be limited to, a base station controller, a base transceiver station, a cell site, a Node B, an e Node B, a g Node B, a radio network controller, and any such entity obvious to a person skilled in the art.

The term “wireless device” or “user equipment (UE)” may refer to a computing device that is latched to the network entity to receive voice and data services. The wireless device may refer to any one of various cellular telephones, personal data assistants (PDA's), palm-top computers, laptop computers with wireless modems, wireless electronic mail receivers, multimedia Internet enabled cellular telephones, and similar personal electronic devices. A wireless device may include a programmable processor and memory. In a preferred embodiment, the wireless device is a cellular handheld device (e.g., a wireless device), which can communicate via a cellular telephone communications network. A person of ordinary skill in the art will appreciate that the terms “wireless device” and “user equipment (UE)” may be used interchangeably throughout the disclosure.

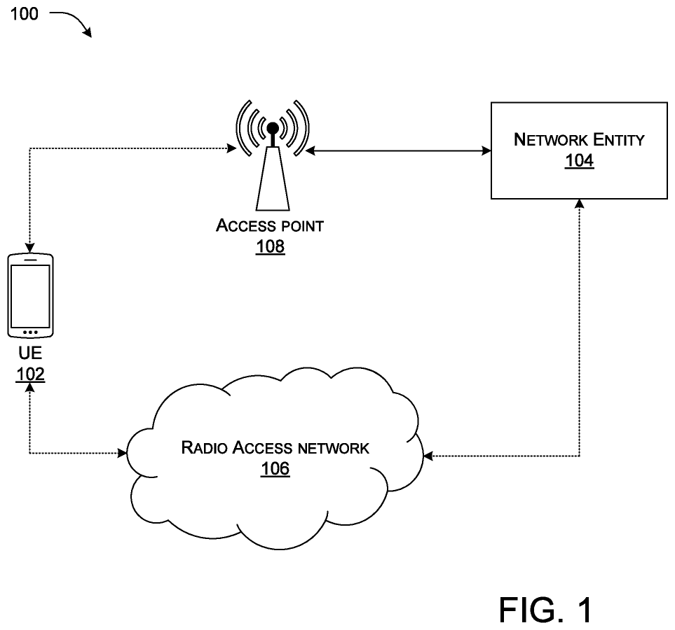

The various embodiments throughout the disclosure will be explained in more detail with reference to FIGS. 1-6.

Referring to FIG. 1, the present disclosure encompasses an exemplary system architecture 100 for data offloading handover restriction of a user from a first RAT type to a second RAT type. The system architecture 100 comprises a user equipment 102 and a network entity 104. Further, the system architecture 100 comprises a radio access network (RAN) 106 and an access point 108/Wi-Fi network for establishing a communication between the user equipment 102 and the network entity 104, wherein an access point network is formed by an access point (AP) 108. Furthermore, the network entity 104, as used herein, may comprise an access and mobility management function (AMF), a trusted wireless access gateway (TWAG), an authentication, authorization, and accounting server (AAA) (for example, 3GPP AAA), a unified data management (UDM), and a home subscriber server (HSS) (not shown in FIG. 1). It may be appreciated that the terms “AAA” and “3GPP AAA” may be used interchangeably throughout the disclosure.

In an embodiment, the network entity 104 may provide a cellular network to the one or more user equipments 102 present in a cellular coverage range of the network entity 104 and thereby, the one or more user equipments 102 may avail voice and data services using the cellular network.

In an embodiment, the network entity 104 performs or restricts data offloading from the first RAT type to the second RAT type. A person of ordinary skill in the art will understand that wireless devices have affinity to handover to Wi-Fi whenever it finds itself in the coverage of a Wi-Fi network (for example, access point network). However, handover from 5G to Wi-Fi 4, 5 AP may lead to degradation of experience and throughput, since Wi-Fi throughput in this case is substantially lower than the 5G throughput. Thus, the present solution provides a mechanism to detect and block such experience degrading handover attempt.

In an embodiment, the system 104 may receive a connection request from a UE 102 for connecting to a non-3GPP access network. The UE 102 may be connected to a 3GPP access network, and where the connection request may include an identifier associated with the UE 102. The identifier may include a called station ID with at least one of a basic service set identifier (BSSID), a SSID, and an access point (AP) group name, and where the SSID may include a network name of the non-3GPP access network requested by the UE 102.

In an embodiment, the type of the 3GPP access network may include one of 4G network or 5G network, and in case of the 3GPP access network being the 4G network, the system 104 may allow a handover of the UE 102 from the 4G network to the non-3GPP access network. In case of the 3GPP access network being the 5G network, the system 104 may determine a generation of Wireless Fidelity (Wi-Fi) of the non-3GPP access network requested by the UE 102 based at least on the identifier, sent by the AP 108.

In an embodiment, in case of the generation of the Wi-Fi being Wi-Fi 6, the system 104 may allow the handover of the UE 102 from the 5G network to the Wi-Fi 6, and in case of the generation of the Wi-Fi being Wi-Fi 4, 5, the system 104 may determine if the UE 102 is connected to a low throughput band of the 5G network or a high throughput band of the 5G network based on the radio frequency information.

In an embodiment, in case of the UE 102 being connected to the low throughput band of the 5G network, the system 104 may allow the handover of the UE 102 from the 5G network to the non-3GPP access network, and where in case of the UE 102 being connected to the high throughput band of the 5G network, the system 104 may reject the handover of the UE 102.

In an embodiment, the system 104 may authenticate the UE 102 based on the identifier. The system 104 may responsive to the authentication, transmit a query to a HSS and UDM server regarding the UE 102 The system 104 may receive information associated with the UE 102 via the HSS and UDM server based on the query. The system 104 may determine a type of the 3GPP access network of the UE 102 and extract radio frequency information based on the information. The information may include at least one of connection status of the UE 102 and location information of the UE 102.

In an embodiment, the system 104 may determine a handover restriction decision of the UE 102 based on comparing the radio frequency information of a cell, for example, a gNodeB/eNodeB cell to which the UE 102 is attached in the 3GPP access network, with the identifier.

Although FIG. 1 shows exemplary components of the system architecture 100, in other embodiments, the system architecture 100 may include fewer components, different components, differently arranged components, or additional functional components than depicted in FIG. 1. Additionally, or alternatively, one or more components of the system architecture 100 may perform functions described as being performed by one or more other components of the system architecture 100.

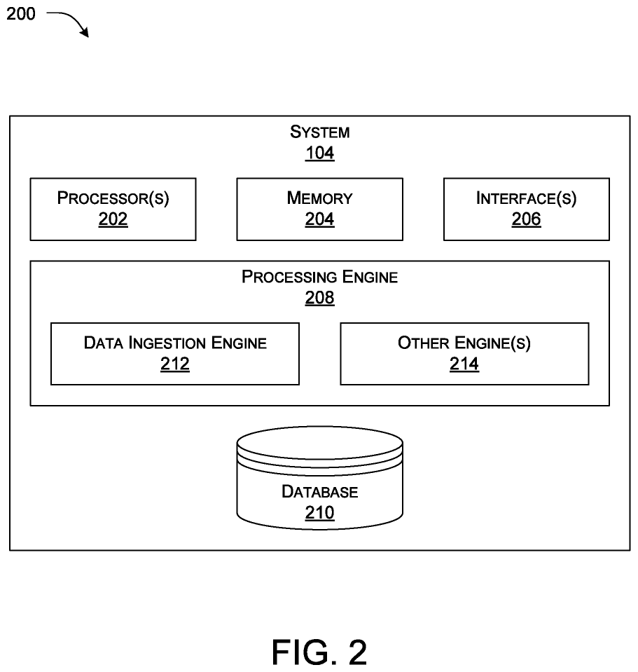

FIG. 2 illustrates an example block diagram 200 of a proposed system 104, in accordance with an embodiment of the present disclosure.

Referring to FIG. 2, the system 104 may comprise one or more processor(s) 202 that may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 104. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as random-access memory (RAM), or non-volatile memory such as erasable programmable read only memory (EPROM), flash memory, and the like.

In an embodiment, the system 104 may include an interface(s) 206. The interface(s) 206 may comprise a variety of interfaces, for example, interfaces for data input and output (I/O) devices, storage devices, and the like. The interface(s) 206 may also provide a communication pathway for one or more components of the system 104. Examples of such components include, but are not limited to, processing engine(s) 208 and a database 210, where the processing engine(s) 208 may include, but not be limited to, a data ingestion engine 212 and other engine(s) 214. In an embodiment, the other engine(s) 214 may include, but not limited to, a data management engine, an input/output engine, and a notification engine.

In an embodiment, the processing engine(s) 208 may be implemented as a combination of hardware and programming (for example, programmable instructions to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 104 may comprise the machine-readable storage medium storing the instructions and the processing resource to execute the instructions, or the machine-readable storage medium may be separate but accessible to the system 104 and the processing resource. In other examples, the processing engine(s) 208 may be implemented by electronic circuitry.

In an embodiment, the processor 202 may receive a connection request via the data ingestion engine 212. The connection request may be received from the UE 102 for connecting to a non-3GPP access network. The processor 202 may store the connection request in the database 210. The UE 102 may be connected to a 3GPP access network, and where the connection request may include an identifier associated with the UE 102. The identifier may include a called station ID with at least one of a BSSID, a SSID, and an AP group name, and where the SSID may include a network name of the non-3GPP access network requested by the UE 102.

In an embodiment, the type of the 3GPP access network may include one of 4G network or 5G network, and in case of the 3GPP access network being the 4G network, the processor 202 may allow a handover of the UE 102 from the 4G network to the non-3GPP access network. In case of the 3GPP access network being the 5G network, the processor 202 may determine a generation of Wi-Fi of the non-3GPP access network requested by the UE 102 based at least on the identifier.

In an embodiment, in case of the generation of the Wi-Fi being Wi-Fi 6, the processor 202 may allow the handover of the UE 102 from the 5G network to the Wi-Fi 6, and in case of the generation of the Wi-Fi being Wi-Fi 4, 5, processor 202 may determine if the UE 102 is connected to a low throughput band of the 5G network or a high throughput band of the 5G network based on the radio frequency information

In an embodiment, in case of the UE 102 being connected to the low throughput band of the 5G network, the processor 202 may allow the handover of the UE 102 from the 5G network to the non-3GPP access network, and where in case of the UE 102 being connected to the high throughput band of the 5G network, the processor 202 may reject the handover of the UE 102.

In an embodiment, the processor 202 may authenticate the UE 102 based on the identifier. The processor 202 may responsive to the authentication, transmit a query to a HSS and UDM server regarding the UE 102. The processor 202 may receive information associated with the UE 102 via the HSS and UDM server based on the query. The processor 202 may determine a type of the 3GPP access network of the UE 102 and extract radio frequency information based on the information. The information may include at least one of connection status of the UE 102 and location information of the UE 102.

In an embodiment, the processor 202 may determine a handover restriction decision of the UE 102 based on comparing the radio frequency information, of a cell to which the UE 102 is attached in the 3GPP access network, with the identifier.

Although FIG. 2 shows exemplary components of the system (108), in other embodiments, the system 104 may include fewer components, different components, differently arranged components, or additional functional components than depicted in FIG. 2. Additionally, or alternatively, one or more components of the system 104 may perform functions described as being performed by one or more other components of the system 104.

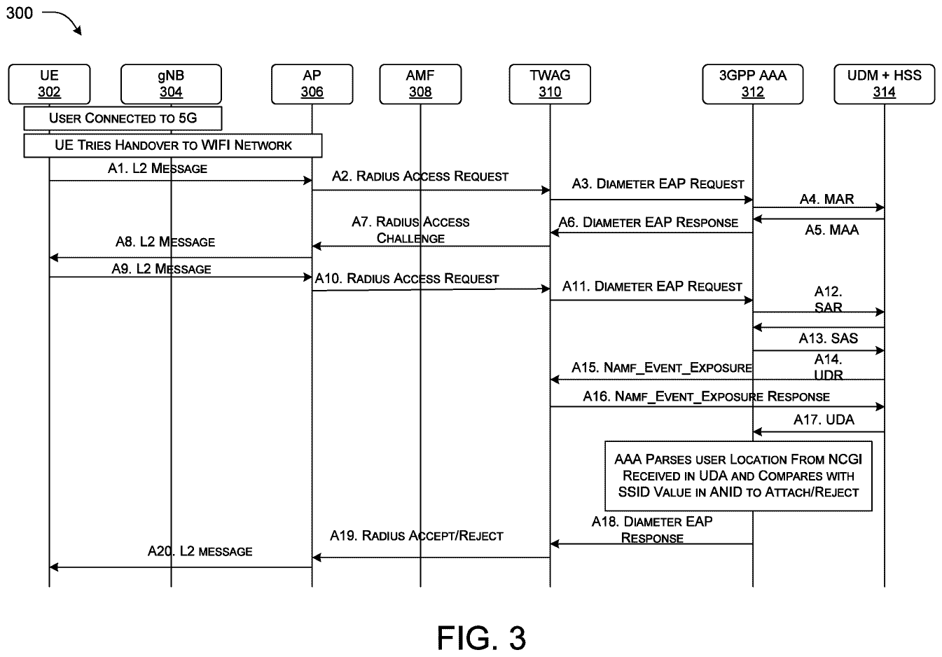

FIG. 3 illustrates an exemplary signal flow diagram 300 of the proposed system 104, in accordance with embodiments of the present disclosure.

Referring to FIG. 3, a wireless device such as a UE 302 is currently connected to a first RAT type, i.e., 3GPP based services (for example, 5G network). More particularly, the UE 302 is connected to a g Node B (gNB) 304. A person of ordinary skill in the art will understand that gNB is a 5G NR next generation radio unit or base station.

As a next step, the UE 302 performs an association with an AP 306. As such, at step A1, the UE 302 attempts a handover to a second RAT type, i.e., non-3GPP based services (for example, Wi-Fi network) by transmitting an L2 message to the AP 306. A person of ordinary skill in the art will understand that the UE 302 and the AP 306 may be similar to the user equipment 102 and the AP 108 of FIG. 1, respectively, in their functionality.

Referring to FIG. 3, at step A2, the AP 306 may be configured to generate a radius access request and transmit the radius access request to a TWAG 310 of a network entity such as the network entity 104 of FIG. 1. In an embodiment, the radius access request may be generated based on a connection request (or, association request) received from the UE 302, i.e., in the form of L2 message. In an embodiment, the connection request and the radius access request may include a called station ID AVP. Alternatively, or additionally, the connection request and the radius access request may comprise an ID associated with the UE 302. A person of ordinary skill in the art will understand that the AVP is a fundamental representation of data in various applications. In an embodiment, the called-station-ID comprises at least a basic service set identifier (BSSID), a SSID, and an AP group name. The BSSID may comprise a medium access control (MAC) address of an AP radio interface. The SSID may comprise a Wi-Fi network name that the UE 302 is trying to connect to. It may be appreciated that APs supporting Wi-Fi 6 broadcast a different SSID from the SSID broadcasted by APs of Wi-Fi 4 and Wi-Fi 5. The AP group name may comprise a name of a group of APs. It may be appreciated that the AP group name may be an operator-defined custom value, which is used to group multiple APs based at least on deployment location, traffic served, user type, wireless controller, and the like.

A person of ordinary skill in the art will understand that Remote Authentication Dial-In User Service (RADIUS) is a networking protocol that provides centralized authentication, authorization, and accounting management for users who connect and use a network service. Request for Comments (RFC) 2865 and 3580 specifies the Radius message and AVPs for communication between AP and TWAG. A person of ordinary skill in the art will understand that a Request for Comments (RFC) is a formal document from the Internet Engineering Task Force (IETF) that contains specifications and organizational notes about topics related to the internet and computer networking, such as routing, addressing and transport technologies.

Referring to FIG. 3, at step A3, the TWAG 310 may be configured to forward values of the called-station-ID received in the radius access message towards an AAA 212. In an embodiment, the TWAG 310 may forward the values of the called-station-ID in a Diameter extensible authentication protocol (EAP) request. A person of ordinary skill in the art will understand that Diameter is an AAA protocol. A person of ordinary skill in the art will appreciate that the format of Diameter EAP request is as follows:

```
<Diameter-EAP-Request>:= < Diameter Header: 268, REQ, PXY >
  < Session-Id >
  { Auth-Application-Id }
  { Origin-Host }
  { Origin-Realm }
  { Destination-Realm }
  { Auth-Request-Type }
  [ Destination-Host ]
```

In an embodiment, the AAA 212 obtains a value of the SSID from the Diameter EAP request at step A3. In another embodiment, the AAA 212 obtains the ID of the UE 302.

Further, at steps A4 to A13, the AAA 212 performs authentication and authorization of the UE 302 as per 3GPP standards. In particular, at step A4, the AAA 312 may be configured to send a multimedia authentication request (MAR) to UDM and HSS 314. In an embodiment, the MAR may comprise at least an ID of the UE 302 for authentication of the UE 302. Further, at step A5, the UDM and HSS 314 may be configured to transmit a multimedia authentication answer (MAA) in response to the MAR to the AAA 312. Thereafter, at step A6, the AAA 312 transmits a Diameter EAP response to the TWAG 310. In an embodiment, the Diameter EAP response is part of a multi-round authentication exchange, indicating that the AAA 312 is expecting a subsequent Diameter EAP request.

Further, at step A7, the TWAG 310 transmits a radius access challenge message to the AP 306, and at step A8, the AP 306 transmits an L2 message to the UE 302 for authenticating the UE 302. Furthermore, at step A9, the UE 302 sends a subsequent connection request (i.e., L2 message) to the AP 306 by way of multi-round authentication process. Subsequently, at step A10, the AP 306 sends a subsequent radius access request to the TWAG 310, and at step A11, the TWAG 310 sends a subsequent Diameter EAP request to the AAA 312.

Referring to FIG. 3, by way of multi-round authentication process, at step A12, the AAA 312 sends a server assignment request (SAR) to the UDM and HSS 314. In an embodiment, the SAR is transmitted from the AAA 312 to the UDM and HSS 314 to register a user associated with the UE 302.

At step A13, the UDM and HSS 314 send a server assignment answer (SAA) to the AAA 312. In an embodiment, the SAA is transmitted from the UDM and HSS 314 to the AAA 212 to confirm the registration of the UE 302.

Referring to FIG. 3, at step A14, the AAA 312 may be configured to perform a query for user state and location using a user data request (UDR) message towards the UDM and HSS 314. In an embodiment, the AAA 312 transmits the UDR message to the UDM and HSS 314 over a Diameter Sh interface to obtain UE's 302 current attach location in radio access network, for example, 4G or 5G.

At steps A15 and A16, the UDM and HSS 314 extract information from the AMF 308 in response to the UDR message received from the AAA 312. In an embodiment, the information may comprise at least security information including, but not limited to, connection status and location information of the UE 302. In an embodiment, the UDM and HSS 314 may obtain this information in step A16.

Referring to FIG. 3, at step A17, the UDM and HSS 314 may send the received information to the AAA 312 in response to the UDR message using a user data answer (UDA) message. In an embodiment, the UDA message may comprise at least connection status and location information of the UE 302 obtained from the AMF 308. In an embodiment, the UDA message may comprise the NCGI. A person of ordinary skill in the art will understand that NCGI is used to identify NR cells globally in 5G networks. In an embodiment, the NCGI is configured in the gNB 304 as per the format depicted in FIG. 3, which will be explained in more detail later in the disclosure.

In accordance with embodiments of the present disclosure, in response to receiving the UDA message, the AAA 312 parses the UDA message to determine current access network type, i.e., 3GPP access network type of the UE 302 (for example, whether the UE 302 is connected to 4G or 5G network). In an embodiment, in case of 5G network, the AAA 312 parses user location from the NCGI received in the UDA message. Additionally, the AAA 312 extracts radio frequency information from the NCGI. Further, the AAA 312 compares the extracted radio frequency information with the SSID value received in the Diameter EAP request message (at steps A3 and/or A11). Based on the comparison, the AAA 312 determines or decides whether to allow (or, attach) the handover requested by the UE 302 or reject the handover. In an embodiment, the AAA 312 uses and/or applies handover restrictions as per below Table 1 to determine whether to allow or reject the handover.

TABLE 1

| | | Handover Allowed/Not |
|---|---|---|
| From | To | Allowed |
| 4G | Wi-fi 4, 5, 6 | Allowed |
| 5G (Low throughput Band) | Wi-fi 4, 5 | Allowed |
| 5G (High throughput Band) | Wi-fi 4, 5 | Not Allowed |
| 5G | Wi-fi 6 | Allowed |

In an exemplary embodiment, if the UE 302 is requesting for a handover from a first RAT type, i.e., 5G with high throughput band, to Wi-Fi 4, 5, then the AAA 312 may determine to reject the handover request of the UE 302.

Referring to FIG. 3, at step A18, the AAA 312 transmits a Diameter EAP response to the TWAG 310, comprising a decision taken at step A17. In an embodiment, the AAA 312 responds with success or rejection based on the handover restriction decision taken at step A17. Thereafter, at step A19, the TWAG 310 conveys the handover rejection decision to the AP 306 via a radius accept/reject message, and at step A20, the AP 306 conveys this information to the UE 202. In an embodiment, the handover is rejected with error code Diameter Authorization Rejected when the handover may result in experience degradation.

Therefore, the present disclosure optimizes handover decisions to maintain and/or improve user experience. It will be appreciated that the steps shown in FIG. 3 are merely illustrative. Other suitable steps may be used, if desired. Moreover, the steps of the flow diagram 300 may be performed in any order and may include additional steps, without departing from the scope of the current disclosure.

3GPP TS 23.401, 23.402, and 24.302 define the architecture for non-3GPP access to EPC core while TS 29.273 specifies AVPs of the Diameter messages used for non-3GPP access. TS 29.328 specifies the Sh interface messages and AVPs.

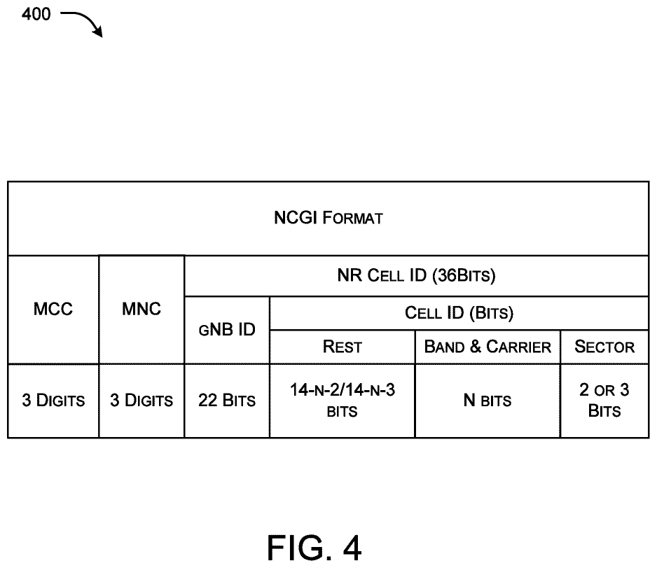

FIG. 4 illustrates a format of the NCGI configured in the gNB such as the gNB 304 of FIG. 3, in accordance with an embodiment of the present disclosure.

Referring to FIG. 4, the NCGI comprises a MCC, a MNC, and an NR cell ID. As shown, the MCC is of 3 digits and the MNC is of 3 digits. In an embodiment, the MNC may be of 2 digits. Further, the NR cell ID has a total size of 36 bits. These 36 bits constitute of gNB ID and cell ID. In an embodiment, the gNB ID has a total size of 22 bits, leaving 14 bits for the cell ID.

In an embodiment, the cell ID comprises at least band and carrier, and sector information, where sector utilizes 2 or 3 bits. Further, band and carrier utilizes “N” bits. It should be understood that “N” may be decided based on a number of combinations of band and carrier. Furthermore, Rest field utilizes the remaining bits, i.e., 14-N-2 or 14-N-3 bits.

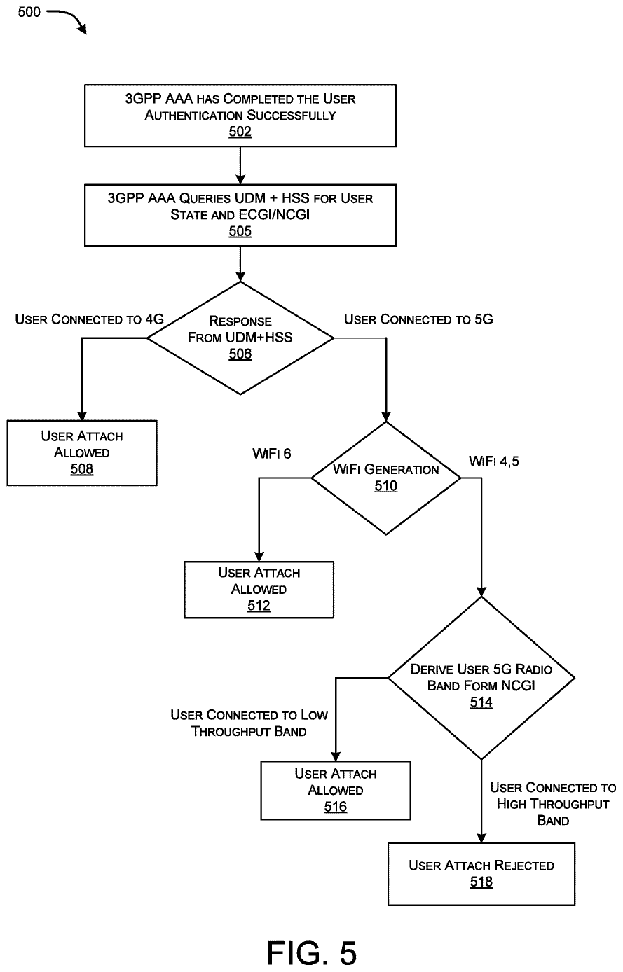

FIG. 5 illustrates an exemplary flow diagram of a method 500 for providing handover restriction decisions, in accordance with embodiments of the present disclosure. It may be appreciated that FIG. 5 be read in light of FIGS. 3 and 4, and hence few portions of FIG. 4 may not be described in detail again for the sake of brevity.

Referring to FIG. 5, at step 502, AAA such as the 3GPP AAA 312 of FIG. 3 successfully completes authentication of a user (for example, the UE 202 of FIG. 3). In an embodiment, the AAA 312 performs authentication and authorization of the UE 302 as per 3GPP standards.

At step 504, the method 500 includes transmitting a query from the AAA 512 to a UDM and HSS (for example, the UDM and HSS 514 of FIG. 3) for user state and location information, i.e., E-UTRAN cell global identifier (ECGI) or NCGI. It should be understood that ECGI is used to identify cells globally, which comprises MCC, MNC, and E-UTRAN cell ID. In an embodiment, the AAA 312 sends a query for the user state and the ECGI/NCGI using a UDR message. A person of ordinary skill in the art will understand that step 504 of method 500 is similar to step A14 of FIG. 3, and hence, may not be described in detail again for the sake of brevity.

Referring to FIG. 5, at step 506, the method 500 includes extracting, by the AAA 312, information from a response received from the UDM and HSS 314. In an embodiment, the AAA 312 receives a UDA message from the UDM and HSS 314 in response to the UDR message. Based on the received UDA message, the AAA 312 extracts at least location information and/or radio frequency information of the UE 302 from the NCGI in the UDA message. Additionally, the AAA 312 compares the extracted information from the NCGI with, for example, SSID value to determine a handover restriction decision. In particular, the AAA 312 determines whether the UE 302 is currently connected to a 4G network type or a 5G network type.

If it is determined that the UE 302 is connected to the 4G network, then at step 508, the method 500 includes allowing the UE 302 to handover to a non-3GPP based network type, for example, a Wi-Fi network through an access point such as the AP 108 of FIG. 1. Further, if it is determined that the UE 302 is connected to the 5G network, then at step 510, the method 500 includes determining a generation of the Wi-Fi requested by the UE 302. In an embodiment, the AAA 312 determines the Wi-Fi generation requested by the UE 302 based on the SSID value in the called-station-ID.

Referring to FIG. 5, if it is determined that the Wi-Fi generation requested by the UE 302 is Wi-Fi 6, then at step 512, the method 500 includes allowing the UE 302 to handover to the Wi-Fi network, i.e., Wi-Fi 6. However, if it is determined that the Wi-Fi generation requested by the UE 302 is Wi-Fi 4, 5, then the method 500 proceeds to step 514, where the AAA 312 derives user station and location information from NCGI. In an embodiment, the AAA 312 extracts user location information and radio frequency information from the NCGI.

In an embodiment, based on the extracted information, i.e., radio frequency information, the AAA 312 determines if the UE 302 is connected to low throughput band of 5G or high throughput band of 5G. If the UE 302 is connected to low throughput band, then the method 500 at step 516 includes allowing the UE 302 to handover to a Wi-Fi network. If the UE 302 is connected to high throughput band, then the method 500 at step 518 includes rejecting the handover of the UE 302 to the Wi-Fi network. In an embodiment, the AAA 312 determines or takes a decision based on handover restrictions defined in Table 1.

A person of ordinary skill in the art will readily ascertain that the illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

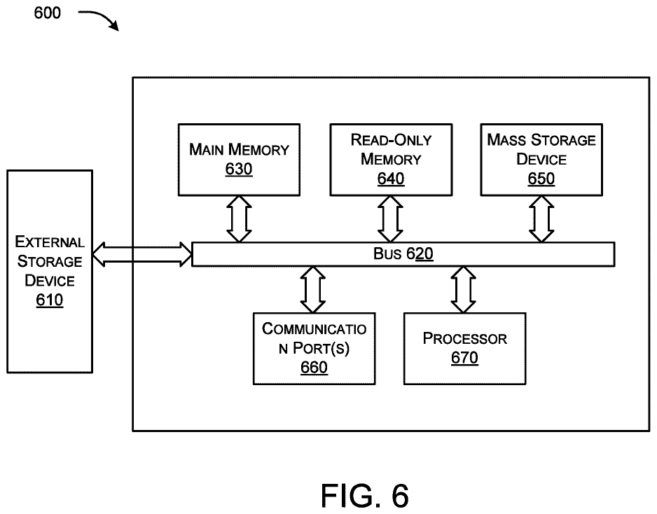

FIG. 6 illustrates an exemplary computer system 600 in which or with which embodiments of the present disclosure may be implemented. In an embodiment, the UE 102/302, the access point 108/306, and/or the network entity 104 including the AAA 312 may be implemented as the computer system 600.

As shown in FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication port(s). The processor 670 may include various modules associated with embodiments of the present disclosure. The communication port(s) 660 may be any of an RS-232 port for use with a modem-based dialup connection, a 10/100 Ethernet port, a Gigabit or 10 Gigabit port using copper or fibre, a serial port, a parallel port, or other existing or future ports. The communication port(s) 660 may be chosen depending on a network, such a Local Area Network (LAN), Wide Area Network (WAN), or any network to which the computer system 600 connects. The main memory 630 may be random-access memory (RAM), or any other dynamic storage device commonly known in the art. The read-only memory 640 may be any static storage device(s). The mass storage device 650 may be any current or future mass storage solution, which can be used to store information and/or instructions.

The bus 620 communicatively couples the processor 670 with the other memory, storage, and communication blocks. Optionally, operator and administrative interfaces, e.g. a display, keyboard, and a cursor control device, may also be coupled to the bus 620 to support direct operator interaction with the computer system 600. Other operator and administrative interfaces may be provided through network connections connected through the communication port(s) 660. Components described above are meant only to exemplify various possibilities. In no way should the aforementioned exemplary computer system 600 limit the scope of the present disclosure.

Therefore, the present disclosure optimizes the handover decisions. In particular, the present disclosure describes restricting the handover from 5G to Wi-Fi if doing so may result in poor throughput experience. Further, the present disclosure ensures that user experience is not degraded due to handover to Wi-Fi Network.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Invention

The present disclosure provides an efficient approach towards handover restriction.

The present disclosure avoids throughput degradation in case of handover.

The present disclosure ensures that user experience is maintained, and not degraded, due to handover from a third generation partnership project (3GPP) based network type to a non-3GPP based network type.

We claim:

1. A system (104) for providing handover restriction decisions, the system (104) comprising:
a processor (202); and
a memory (204) operatively coupled to the processor (202), wherein said memory (204) stores instructions which, when executed by the processor (202), cause the processor (202) to:
receive a connection request from a user equipment (UE) (102) for connecting to a non-third generation partnership project (non-3GPP) access network, wherein the UE (102) is connected to a 3GPP access network, and wherein the connection request comprises an identifier associated with the UE (102);
authenticate the UE (102) based on the identifier;
responsive to the authentication, transmit a query to a home subscriber server (HSS) and unified data management (UDM) server regarding the UE (102);
receive information associated with the UE (102) via the HSS and UDM server based on the query;
determine a type of the 3GPP access network of the UE (102) and extract radio frequency information based on the information; and
determine a handover restriction decision of the UE (102) based on comparing the radio frequency information, of a cell to which the UE (102) is attached in the 3GPP access network, with the identifier.

2. The system (104) as claimed in claim 1, wherein the type of the 3GPP access network comprises one of: 4G network or 5G network, and wherein the processor (202) is to allow a handover of the UE (102) from the 4G network to the non-3GPP access network.

3. The system (104) as claimed in claim 2, wherein in case of the 3GPP access network being the 5G network, the processor (202) is to determine a generation of Wireless Fidelity (Wi-Fi) of the non-3GPP access network, requested by the UE (102), based at least on the identifier.

4. The system (104) as claimed in claim 3, wherein in case of the generation of the Wi-Fi being Wi-Fi 6, the processor (202) is to allow the handover of the UE (102) from the 5G network to the Wi-Fi 6, and wherein in case of the generation of the Wi-Fi being Wi-Fi 4, 5, the processor (202) is to determine if the UE (102) is connected to a low throughput band of the 5G network or a high throughput band of the 5G network based on the radio frequency information.

5. The system (104) as claimed in claim 4, wherein in case of the UE (102) being connected to the low throughput band of the 5G network, the processor (202) is to allow the handover of the UE (102) from the 5G network to the non-3GPP access network, and wherein in case of the UE (102) being connected to the high throughput band of the 5G network, the processor (202) is to reject the handover of the UE (102).

6. The system (104) as claimed in claim 1, wherein the identifier comprises a called station ID including at least one of: a basic service set identifier (BSSID), a SSID, and an access point (AP) group name, and wherein the SSID comprises a network name of the non-3GPP access network requested by the UE (102).

7. The system (104) as claimed in claim 1, wherein the information comprises at least one of: connection status of the UE (102) and location information of the UE (102).

8. A method for providing handover restriction decisions, the method comprising:
receiving, by a processor (202) associated with a system (104), a connection request from a user equipment (UE) (102) for connecting to a non-third generation partnership project (non-3GPP) access network, wherein the UE (102) is connected to a 3GPP access network, and wherein the connection request comprises an identifier associated with the UE (102);
authenticating, by the processor (202), the UE (102) based on the identifier;
responsive to the authentication, transmitting, by the processor (202), a query to a home subscriber server (HSS) and unified data management (UDM) server regarding the UE (102);
receiving, by the processor (202), information associated with the UE (102) via the HSS and UDM server based on the query;
determining, by the processor (202), a type of the 3GPP access network of the UE (102) and extracting radio frequency information based on the information; and
determining, by the processor (202), a handover restriction decision of the UE (102) based on comparing the radio frequency information, of a cell to which the UE (102) is attached in the 3GPP access network, with the identifier.

9. The method as claimed in claim 8, wherein the type of the 3GPP access network comprises one of: 4G network or 5G network, and wherein the method comprises allowing, by the processor (202), a handover of the UE (102) from the 4G network to the non-3GPP access network.

10. The method as claimed in claim 9, wherein in case the 3GPP access network is the 5G network, the method comprises determining, by the processor (202), a generation of Wireless Fidelity (Wi-Fi) of the non-3GPP access network, requested by the UE (102), based at least on the identifier.

11. The method as claimed in claim 10, wherein in case the generation of the Wi-Fi is Wi-Fi 6, the method comprises allowing, by the processor (202), the handover of the UE (102) from the 5G network to the Wi-Fi 6, and wherein in case the generation of the Wi-Fi is Wi-Fi 4, 5, the method comprises determining, by the processor (202), if the UE (102) is connected to a low throughput band of the 5G network or a high throughput band of the 5G network based on the radio frequency information.

12. The method as claimed in claim 11, wherein in case the UE (102) is connected to the low throughput band of the 5G network, the method comprises allowing, by the processor (202), the handover of the UE (102) from the 5G network to the non-3GPP access network, and wherein in case the UE (102) is connected to the high throughput band of the 5G network, the method comprises rejecting, by the processor (202), the handover of the UE (102).

13. The method as claimed in claim 8, wherein the identifier comprises a called station ID including at least one of: a basic service set identifier (BSSID), a SSID, and an access point (AP) group name, and wherein the SSID comprises a network name of the non-3GPP access network requested by the UE (102).

14. The method as claimed in claim 8, wherein the information comprises at least one of: connection status of the UE (102) and location information of the UE (102).

15. A user equipment (UE) (102) for sending requests, the UE (102) comprising:
one or more processors communicatively coupled to a processor (202) associated with a system (104), wherein the one or more processors are coupled with a memory, and wherein said memory stores instructions which, when executed by the one or more processors, cause the one or more processors to:
transmit a connection request to the processor (202) for connecting to a non-third generation partnership project (non-3GPP) access network, wherein the UE (102) is connected to a 3GPP access network, and wherein the connection request comprises an identifier associated with the UE (102);
wherein the processor (202) is configured to:
authenticate the UE (102) based on the identifier;
responsive to the authentication, transmit a query to a home subscriber server (HSS) and unified data management (UDM) server regarding the UE (102);
receive information associated with the UE (102) via the HSS and UDM server based on the query;
determine a type of the 3GPP access network of the UE (102) and extract radio frequency information based on the information; and
determine a handover restriction decision of the UE (102) based on comparing the radio frequency information, of a cell to which the UE (102) is attached in the 3GPP access network, with the identifier.

16. A non-transitory computer readable medium comprising a processor with executable instructions, causing the processor to:
receive a connection request from a user equipment (UE) (102) for connecting to a non-third generation partnership project (non-3GPP) access network, wherein the UE (102) is connected to a 3GPP access network, and wherein the connection request comprises an identifier associated with the UE (102);
authenticate the UE (102) based on the identifier;
responsive to the authentication, transmit a query to a home subscriber server (HSS) and unified data management (UDM) server regarding the UE (102);
receive information associated with the UE (102) via the HSS and UDM server based on the query;
determine a type of the 3GPP access network of the UE (102) and extract radio frequency information based on the information; and
determine a handover restriction decision of the UE (102) based on comparing the radio frequency information, of a cell to which the UE (102) is attached in the 3GPP access network, with the identifier.
